(19) United States
(12) Patent Application Publication
(10) Pub. No.: US 2018/0345788 A1
(43) Pub. Date: Dec. 6, 2018

(54) VEHICLE, FLOOR MOUNTED, FOOT ACTUATED, PANIC KILL SWITCH SAFEGUARD

(71) Applicants: John Puchowicz, Shelton, CT (US); Michael Joseph Puchowicz, Mesa, AZ (US)

(72) Inventors: John Puchowicz, Shelton, CT (US); Michael Joseph Puchowicz, Mesa, AZ (US)

(21) Appl. No.: 16/004,615

(22) Filed: Jun. 11, 2018

Related U.S. Application Data
(63) Continuation-in-part of application No. 15/418,965, filed on Jan. 30, 2017.
(60) Provisional application No. 62/290,910, filed on Feb. 3, 2016.

(51) Int. Cl. B60K 20/04; B60K 28/00; F02D 11/10; B60R 16/03; F02D 17/04; F02D 29/02; F02D 33/00; F02D 41/04; F02D 41/22; F02M 37/00; F02M 37/08; B60K 26/02

(52) U.S. Cl. CPC B60K 20/04; B60Q 1/46; F02D 11/107; B60R 16/0315; F02D 17/04; F02D 29/02; F02D 33/006; F02D 41/042; F02D 41/22; F02M 37/0023; F02M 37/007; F02M 37/08; B60K 26/02; F02M 2037/085; B60K 28/00

(57) ABSTRACT

A vehicle kill switch comprising: a foot actuatable floor mounted switch; a vehicle stopping means in signal communication with the foot actuatable floor mounted switch. A vehicle kill switch comprising: a first foot actuatable floor mounted switch; a first solenoid in signal communication with the first foot actuatable floor mounted switch; a ground in signal communication with the first foot actuatable floor mounted switch; a first fuel valve in operable communication with the first solenoid; a second foot actuatable floor mounted switch; a second solenoid in signal communication with the second foot actuatable floor mounted switch and in communication with the first foot actuatable floor mounted switch; a ground in signal communication with the second foot actuatable floor mounted switch; a second fuel valve in operable communication with the second solenoid; where when the first switch is closed, the first solenoid and second solenoid become in signal communication with ground, and the first solenoid and second solenoid closes the first fuel valve and second fuel valve, respectively, which in turns stops the flow of fuel to the vehicle engine; and where when the second switch is closed, the first solenoid and second solenoid become in signal communication with ground, and the first solenoid and second solenoid closes the first fuel valve and second fuel valve, respectively, which in turns stops the flow of fuel to the vehicle engine. A vehicle kill switch retrofit kit comprising: a foot actuatable floor mounted switch, the foot actuatable floor mounted switch comprising a first contact located on a first side of the switch, and a second contact located on a second side of the switch; a first wire connected at a first end to a first contact on the foot actuatable floor mounted switch, with a second end configured to attach to an vehicle component; a second wire connected at a first end to a second contact on the foot actuatable floor mounted switch, with a second end configured to attach to an vehicle component; and a floor mounting bracket configured to attach the foot actuatable floor mounted switch to the floor of a vehicle.

### CROSS-REFERENCES

This patent application is a continuation-in-part of U.S. patent application Ser. No. 15/418,965 by inventors John Puchowicz and Michael Puchowicz entitled “VEHICLE, FLOOR MOUNTED, FOOT ACTUATED, PANIC KILL SWITCH SAFEGUARD,” filed on Jan. 30, 2017, and which application is fully incorporated by reference herein. U.S. patent application Ser. No. 15/418,965 claims the benefit of U.S. Provisional Patent Application No. 62/290,910 by inventors John Puchowicz and Michael Joseph Puchowicz entitled “UNINTENDED ACCELERATION, HACKER ATTACK, UNFORESEEN EMERGENCY SAFEGUARD,” filed on Feb. 3, 2016, and which provisional application is fully incorporated by reference herein.

### TECHNICAL FIELD

This invention relates to a device which may aid in stopping a vehicle, and more specifically to a with a foot activated switch that may aid in stopping a vehicle.

### BACKGROUND

Sudden unintended acceleration (“SUA”) due to vehicle malfunction is a grave concern for motorists, automakers, and government agencies. The issue first came to mainstream public attention after 700 accidents resulting in 6 deaths were linked to SUA in the 1982-87 model year Audi 5000s. In the subsequent years, incidents of SUA have been reported for Jeep, Ford, Kia, and Toyota vehicles. SUAs starting in model year 2002 vehicles, ultimately led to incidents resulting in 1.2 billion dollars in criminal penalties, 1.2 billion dollars paid to settle class action lawsuits, as well as an additional 400 wrongful death and personal injury settled separately. In addition, in 2015 multiple reports made headlines for hackers being able to seize control of drive by wire vehicles. Such drive by wire systems will now be a target for criminal, terrorist, and hacker activity. It is clear that a simple robust system is necessary to allow motorist to bring their vehicle to a controlled stop under any conditions of a vehicle system takeover, malfunction, or failure.

Hackers may be able to seize control of drive by wire vehicle. Automakers cannot guarantee a true 100% fail-safe defense. Solutions under development are only stop gap measures. They are, and will remain vulnerable to a hacker attack, mechanical, and electronic failures.

Thus there is a need for a vehicle kill switch that can overcome the above listed and other disadvantages.

### SUMMARY OF THE INVENTION

The disclosed invention relates to a vehicle kill switch comprising: a foot actuatable floor mounted switch; a vehicle stopping means in signal communication with the foot actuatable floor mounted switch .

The invention also relates to a vehicle kill switch comprising: a first foot actuatable floor mounted switch; a first solenoid in signal communication with the first foot actuatable floor mounted switch; a ground in signal communication with the first foot actuatable floor mounted switch; a first fuel valve in operable communication with the first solenoid; a second foot actuatable floor mounted switch; a second solenoid in signal communication with the second foot actuatable floor mounted switch and in communication with the first foot actuatable floor mounted switch; a ground in signal communication with the second foot actuatable floor mounted switch; a second fuel valve in operable communication with the second solenoid; where when the first switch is closed, the first solenoid and second solenoid become in signal communication with ground, and the first solenoid and second solenoid closes the first fuel valve and second fuel valve, respectively, which in turns stops the flow of fuel to the vehicle engine; and where when the second switch is closed, the first solenoid and second solenoid become in signal communication with ground, and the first solenoid and second solenoid closes the first fuel valve and second fuel valve, respectively, which in turns stops the flow of fuel to the vehicle engine.

In addition, the invention relates to a vehicle kill switch retrofit kit comprising: a foot actuatable floor mounted switch, the foot actuatable floor mounted switch comprising a first contact located on a first side of the switch, and a second contact located on a second side of the switch; a first wire connected at a first end to a first contact on the foot actuatable floor mounted switch, with a second end configured to attach to an vehicle component; a second wire connected at a first end to a second contact on the foot actuatable floor mounted switch, with a second end configured to attach to an vehicle component; and a floor mounting bracket configured to attach the foot actuatable floor mounted switch to the floor of a vehicle.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a schematic view of a fuel pump embodiment of the invention;

FIG. 2 is a schematic view of a fuel pump controller embodiment of the invention;

FIG. 3 is a schematic view of an automatic transmission controller embodiment of the invention;

FIG. 4 is a schematic view of a fuel valve with bypass line embodiment of the invention;

FIG. 5 is a schematic view of a fuel valve embodiment of the invention;

FIG. 6 is a schematic view of a multiplexer, CPU, and bypass line embodiment of the invention;

FIG. 7 is a schematic view of a multiplexer and CPU embodiment of the invention;

FIG. 8 is a schematic view of a redundant embodiment of the invention;

FIG. 9 is a schematic view of a retrofit kit embodiment of the invention; and

FIG. 10 is a schematic view of an electric vehicle embodiment of the invention.

### DETAILED DESCRIPTION

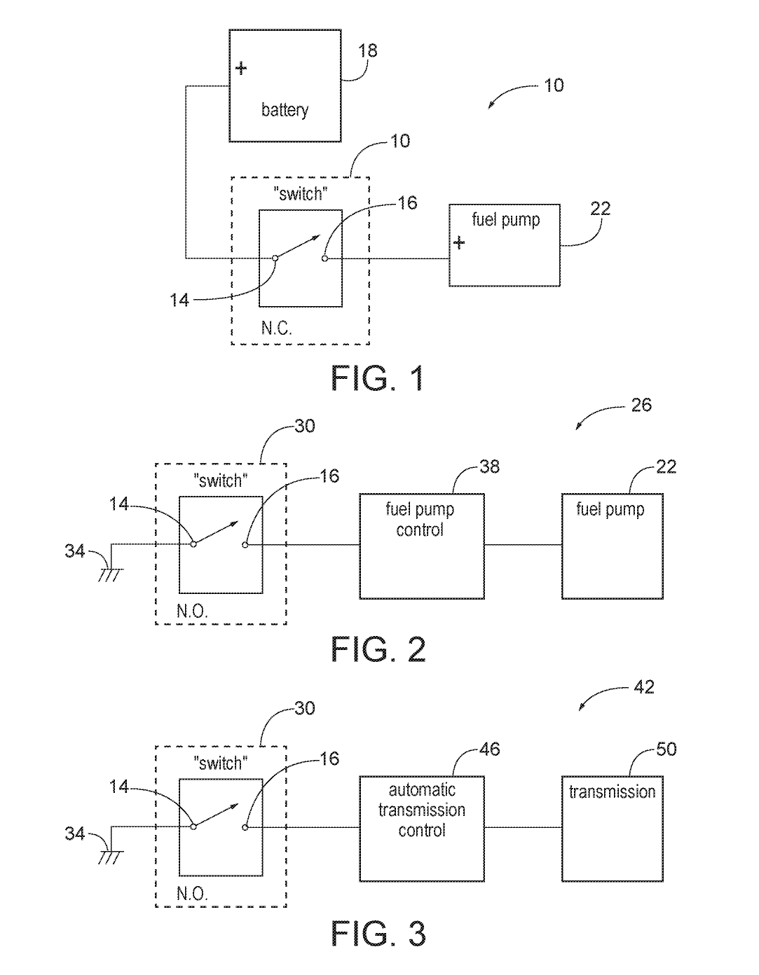

FIG. 1 shows one embodiment of the vehicle kill switch 10. A switch 30 is shown. The switch 30 may be mounted in the floor of the driver's compartment in the vehicle and configured such that the driver may simply use their foot to press on the switch 30 to activate the switch 30. In this embodiment, the normally closed switch 30 is normally closed and the switch contacts 14, 16 are wired in series with the fuel pump power input (generally the vehicle battery 18) and the fuel pump 22. When the switch is opened (as shown in FIG. 1), the open contacts 14 interrupt the power to the pump 22, terminating fuel flow to the engine. A driver then brings the vehicle to a stop without brake or steering vacuum assist.

FIG. 2 shows another embodiment of the vehicle kill switch 26. In this embodiment, the switch 30 is normally open, and one of the normally open contacts 14 is grounded to ground 34. The second contact 16 is in signal communication to the fuel pump control 38. Upon switch contact closure, the fuel pump control 38 is in communication with ground 34, and terminates fuel flow to the engine. The driver then may bring the vehicle to a stop without brake or steering vacuum assist.

FIG. 3 is another embodiment of the vehicle kill switch 42. In this embodiment, the switch 30 is normally open, and one of the normally open contacts 14 is grounded to ground 34. The second contact 16 is in signal communication with an automatic transmission controller 46. Upon switch 30 closure, the automatic transmission controller 46 switches the transmission into neutral or other suitable selection. Now, the vehicle will no longer accelerate, and the driver is able to bring the vehicle to a safe stop.

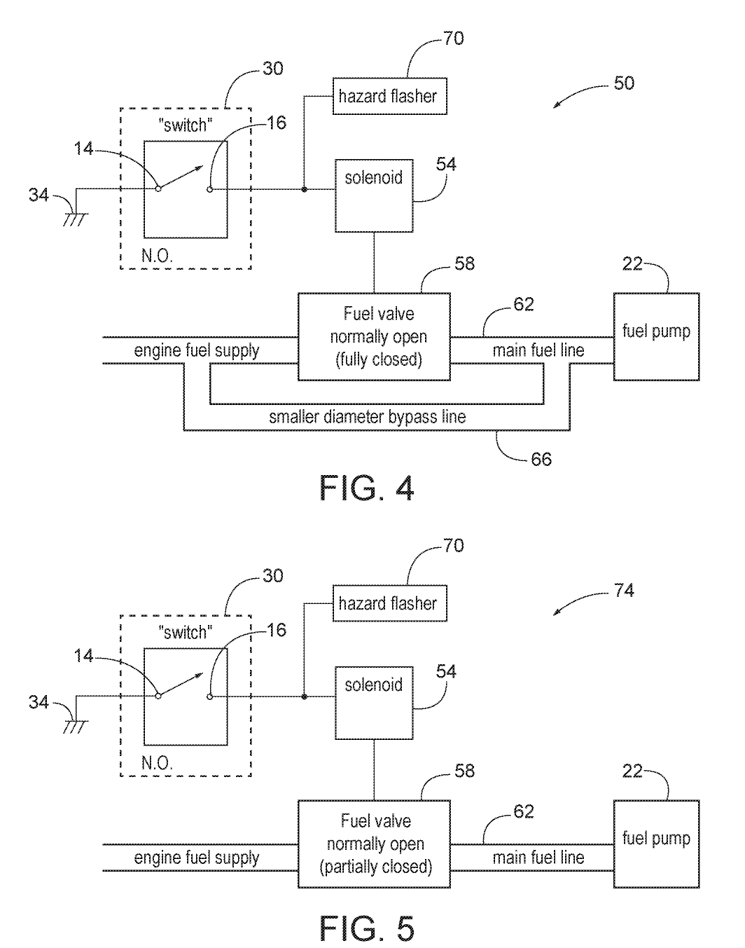

FIG. 4 shows another embodiment of the vehicle kill switch 50. In this embodiment, the switch 30 is normally open, and one of the normally open contacts 14 is grounded to ground 34. The second contact 16 is in signal communication with a solenoid 54 controlling a normally open fuel valve 58. When the switch 30 is closed, the valve 58 closes fully, interrupting the fuel flow in the main fuel line 62. Reduced fuel volume flows in the bypass line 66, allowing just enough fuel to the engine to allow the driver to safely control the vehicle to a stop. In another embodiment, the second contact 16 may also be in signal communication with the hazard lights 70 on the vehicle, such that when the switch 30 is closed, the hazard lights 70 will activate.

FIG. 5 shows another embodiment of the vehicle kill switch 74. In this embodiment, the switch 30 is normally open, and one of the normally open contacts 14 is grounded to ground 34. The second contact is connected to the solenoid controlling the normally open fuel “valve”. The second contact 16 is in signal communication with a solenoid 54 controlling a normally open fuel valve 58. When the switch 30 is closed, the solenoid 54 becomes in signal communication with ground 34, and causes the valve 58 to close fully, interrupting the fuel flow in the main fuel line 62. The valve 30 may have a progressive mechanical closure to gradually reduce the flow rate to prevent engine shut off with an abrupt fuel reduction. If functional, the CPU can emulate this progressive valve closure with fuel flow control. The CPU may be the vehicle's main onboard CPU, or may be a ROM CPU dedicated to the kill switch system. In another embodiment, the second contact 16 may also be in signal communication with the hazard lights 70 on the vehicle, such that when the switch 30 is closed, the hazard lights 70 will activate.

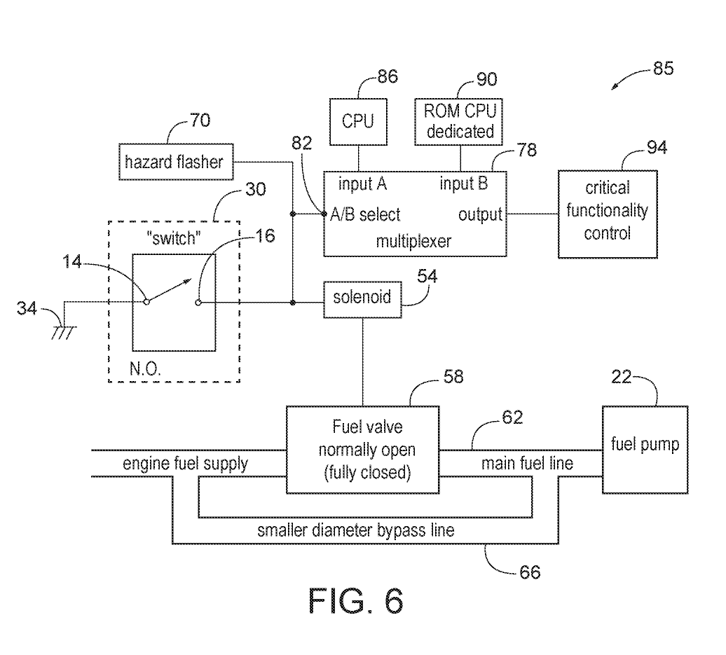

Another embodiment 85 of the vehicle kill switch is shown in FIG. 6. In this embodiment, the switch 30 is normally open, and one of the normally open contacts 14 is grounded to ground 34. The second contact 16 is in signal communication with a solenoid 54 controlling a normally open fuel valve 58. When the switch 30 is closed, the valve 58 closes fully, interrupting the fuel flow in the main fuel line 62. Reduced fuel volume flows in the bypass line 66, allowing just enough fuel to the engine to allow the driver to safely control the vehicle to a stop. In another embodiment, the second contact 16 may also be in signal communication with the hazard lights 70 on the vehicle, such that when the switch 30 is closed, the hazard lights 70 will activate. The second contact 16 is also in signal communication with a select input 82 of a 2 to 1 multiplexer 78. When the switch 30 closes, the multiplexer 78 switches critical control 94 from the main CPU 86 of the vehicle to the hard wired dedicated ROM CPU 90. The ROM CPU 90 assumes control housekeeping duties in bringing the vehicle to a stop.

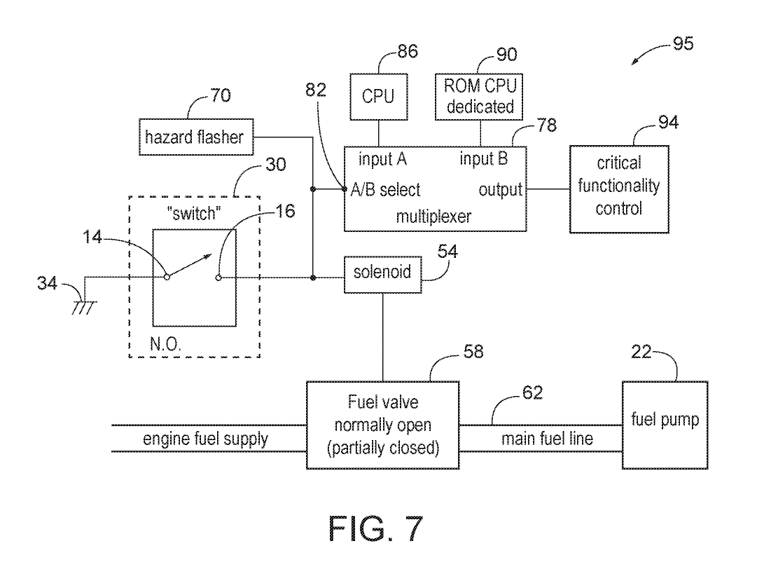

FIG. 7 shows another embodiment 95 of the vehicle kill switch. In this embodiment, the switch 30 is normally open, and one of the normally open contacts 14 is grounded to ground 34. The second contact 16 is in signal communication with a solenoid 54 controlling a normally open fuel valve 58. When the switch 30 is closed, the valve 58 closes fully, interrupting the fuel flow in the main fuel line 62. In another embodiment, the second contact 16 may also be in signal communication with the hazard lights 70 on the vehicle, such that when the switch 30 is closed, the hazard lights 70 will activate. The second contact 16 is also in signal communication with a select input 82 of a 2 to 1 multiplexer 78. When the switch 30 closes, the multiplexer 78 switches critical control 94 from the main CPU 86 of the vehicle to the hard wired dedicated ROM CPU 90. The ROM CPU 90 assumes control housekeeping duties in bringing the vehicle to a stop.

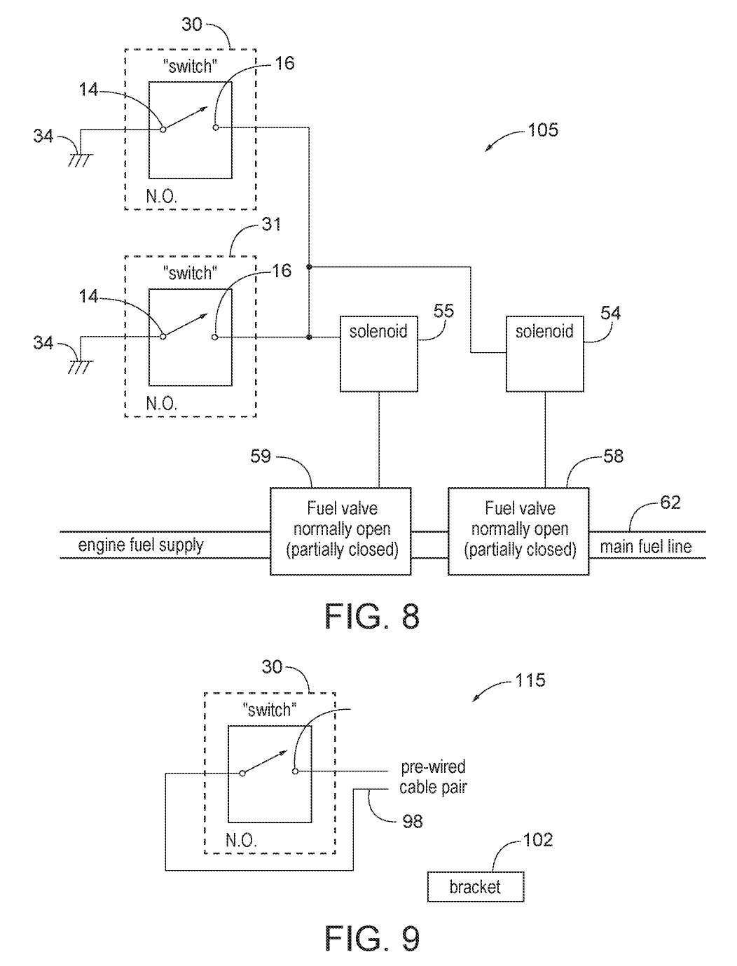

FIG. 8 shows another embodiment 105 of the kill switch. In this embodiment, a first switch 30 is in signal communication with a first solenoid 54 and a second solenoid 55. The first solenoid 54 is in operative contact with the first fuel valve 58. The second solenoid 55 is in operative contact with the second fuel valve 59. The first switch 30 is normally open, and one of the normally open contacts 14 is grounded to ground 34. The second contact 16 is in signal communication with a first solenoid 54 controlling a normally open first fuel valve 58, and in signal communication with a second solenoid 55 controlling a normally open second fuel valve 59. When the first switch 30 is closed, the first solenoid 54 closes the first valve 58 fully and the second solenoid 55 closes the second valve 59 fully, both valves 58, 59 interrupting the fuel flow in the main fuel line 62. Similarly, when the second switch 31 is closed, the first solenoid 54 closes the first valve 58 fully and the second solenoid 55 closes the second valve 59 fully, both valves 58, 59 interrupting the fuel flow in the main fuel line 62. When the valves 58, 59 are closed the fuel flow in the main fuel line 62 is closed, and the driver can steer the vehicle to a safe stop. This is a redundant system, so if the first switch 30 fails, the first solenoid 54 fails or the first valve 58 fails, then the second switch 32, second solenoid 55, and second valve 59 can act as a backup, and vice versa. There may be additional switches, solenoids, and valves for additional redundancies. The switches 30, 31 are configured to act in unison upon foot actuation. The fuel valves 58, 59 are connected in series with each another.

FIG. 9 shows another embodiment 115 of the kill switch. This embodiment 115 is a retrofit kit that comprises a switch 30, a pre-wired cable pair 98 configured to connect to a fuel pump, or other component in a vehicle, and a floor mounting bracket 102.

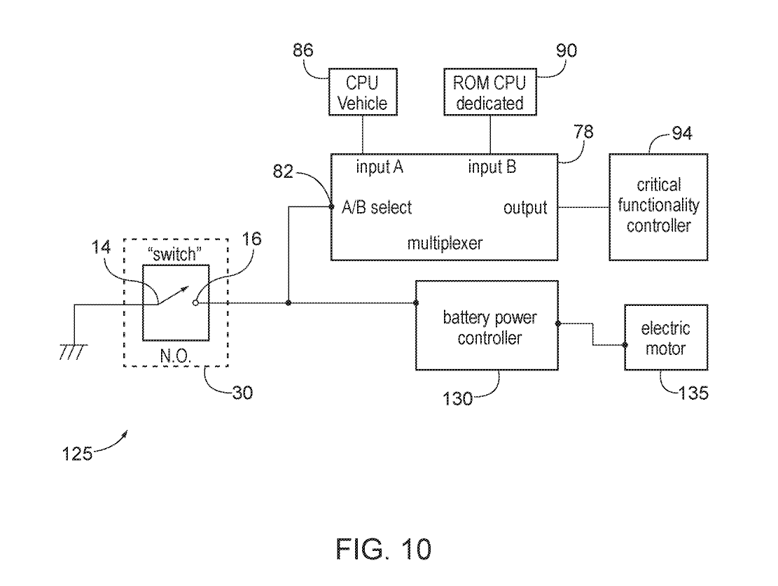

FIG. 10 shows another embodiment 125 of the vehicle kill switch for an electric vehicle. In this embodiment, the switch 30 is normally open, and one of the normally open contacts 14 is grounded to ground 34. The second contact 16 is in signal communication with a battery power controller 130. The battery power controller 130 controls the battery supplying power to the electric motor 135 of an electric vehicle. When the switch 30 is closed, the battery power controller 130 stops power to the electric motor 135 of the electric vehicle. The second contact 16 may also in signal communication with a select input 82 of a 2 to 1 multiplexer 78. When the switch 30 closes, the multiplexer 78 switches critical control 94 from the main CPU 86 of the vehicle to the hard wired dedicated ROM CPU 90. The ROM CPU 90 assumes control housekeeping duties in bringing the vehicle to a stop.

The disclosed vehicle kill switch may have the following three characteristics. Characteristic 1: cut or limit the fuel flow to the engine. This can be achieved by having the main fuel line valve closed, with reduced volume fuel flow in a bypass line. Alternatively, the main fuel line valve may be partially closed, eliminating the need for the bypass line. Power steering and brake vacuum may be maintained, enabling the motorist to bring the vehicle to a safe stop. In a fault tolerant system, N fuel valves may be connected in series, where N is a whole number. Each fuel may have its own solenoid. Wiring to each such solenoid may be direct, and not daisy chained. In a fault tolerant system, N switches may be implemented in parallel, and act in unison. The second characteristic is to negate a hacker attack. In order to provide safeguards against a hacker, a dedicated “hard wired” ROM CPU controller is required. ROM based code must have 100% immunity to any modification by an internal or external source. The ROM CPU may have its own independent RAM and ACLU unit. ROM operating code must not be volatile or susceptible to modification. For example a flashrom able device may be updated at a dealership and not remotely. The ROM CPU may be a physically separate, discrete device, although not necessarily so for economic considerations. The hard wired ROM CPU manages the vehicle to a stop from a SUA, hacker attack, or any other unforeseen emergency. The ROM CPU functionality may be limited to managing engine timing, fuel flow, windshield wipers, headlights, door locks, brakes, and all other critical functionality necessary to bring a vehicle to a safe stop. Input from the switch may be wired directly to the select input of a 2 to 1 multiplexer. The multiplexer may be electronic or mechanical, or a combination. The multiplexer switches critical functionality from the standard CPU control to the dedicated ROM CPU. Upon engine start, an audio alert or a visual display may remind the motorist of the availability of the kill switch. In one embodiment, with the vehicle's transmission in neutral, the motorist may actuate the switch to test it, and turns off the reminder. The ROM CPU controller may be 100% switchover ready by monitoring the critical engine sensors all the time. The third characteristic may be to shift an the vehicle transmission into neutral: In an automatic transmission with manual shift linkage, the foot actuated pedal, akin to a manual clutch pedal, shifts the linkage into neutral. A floor or side mounted mechanical “plunger,” foot or leg actuated, shifts the linkage into neutral. In automatic transmissions with electronic shift control the electronic controller shifts to neutral or other choice upon kill switch actuation.

The disclosed invention allows a driver to activate the kill switch in a critical situation to curtail fuel flow by an electro mechanical valve that remains functional under all other critical vehicle system failures. Concurrently, the limited functionality ROM CPU takes over the vehicle management, thwarting a hacker attack or any other unforeseen deadly emergency, while guiding the vehicle to a safe stop. The foot actuated switch can be any type of device that the motorist can actuate at will. The fuel cut off valve can be any suitable valve that can restrict and/or stop fuel flow. The driver may actuate the kill switch in a critical emergency such as a SUA, an autopilot malfunction, a hacker attack, a texting distraction, a medical emergency such as a stroke or heart attack, while under the influence, or any other unforeseen potentially deadly emergency. The kill switch may be foot (or leg) actuated to be a viable lifesaving safeguard.

The kill switch may also be placed on the side, door, under the dash, on the steering column, or any other location that can still be reached by the motorist's foot or leg.

This invention has many advantages. The disclosed floor mounted, foot actuated kill switch, will enable motorists to limit the fuel supply to the engine. The invention can negate a hacker attack. The invention may shift transmission into neutral. The invention gives motorists a safeguard against many emergencies, hacker attacks, and/or a critical electrical or mechanical failure resulting in a SUA. The invention may ensure that the vehicle comes to a safe stop in case of a medical emergency such as a stroke, or heart attack, distracted cell phone or electronic device user, or any other distraction or negligent activity. The invention may provide the motorists with a fail-safe means to negate: Malware or hacker induced failure in a drive by wire throttle control; other electrical or mechanical failures leading to an uncontrolled and unabated fuel delivery to the engine. The invention offers a life-saving defense. The invention is devoid of any speculative “fuzzy logic” guesswork solutions, devoid of any hidden software bugs, devoid of electronic control failures, devoid of optical or mechanical sensor failures, devoid of mechanical linkage failures, and is immune to a hacker attack. The invention is reliant on the driver's own judgment to make a critical life-saving decision. This invention may ensure that the switch floor location may be the same for all automobiles, independent of automaker or model number. The location of floor switch may be mutually agreed upon or mandated by a vehicle organization or government entity. No precious lifesaving seconds will be lost searching for the ignition turn off location or turn off procedure in an unfamiliar vehicle, whether it is a personal vehicle, a brand new vehicle, a friend's, relative's or a totally unfamiliar rental vehicle.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A vehicle kill switch for an electric vehicle comprising:
a foot actuatable floor mounted switch;
a battery power controller in signal communication with the foot actuatable floor mounted switch;
wherein when the foot actuatable floor mounted switch is actuated, the battery power controller stops the flow of power to an electric motor of the electric vehicle.

2. The vehicle kill switch of claim 1, further comprising:
a ground in signal communication with the foot actuatable floor mounted switch;
wherein when the switch is closed, the battery power controller is in signal communication with the ground and the battery power controller stops the flow of power to the electric motor.

3. The vehicle kill switch of claim 2, further comprising:
a hazard light in signal communication with the switch, the hazard light configured to activate on when the hazard light is in signal communication with the ground.

4. The vehicle kill switch of claim 3, further comprising:
a multiplexer in signal communication with the switch;
a vehicle CPU in signal communication with the multiplexer;
a dedicated rom CPU in signal communication with the multiplexer;
wherein when the switch is opened, the multiplexer is not in signal communication with ground, and vehicle CPU is in control of the vehicle via the multiplexer;
wherein when the switch is closed, the multiplexer is in signal communication with the ground, the multiplexer switches control of the vehicle from the vehicle CPU to the dedicated ROM CPU.
